(19) United States
(12) Patent Application Publication
(10) Pub. No.: US 2012/0144997 A1
(43) Pub. Date: Jun. 14, 2012

(54) CYLINDER PRESSURE ADJUSTER OF A MOTOR

(76) Inventor: Aulis Pohjalainen, Kerimaki (FI)

(21) Appl. No.: 13/391,182

(22) PCT Filed: Jun. 23, 2010
(86) PCT No.: PCT/FI2010/000043

§ 371 Date: Feb. 17, 2012

(30) Foreign Application Priority Data
Aug. 17, 2009 (FI) 20090300

(51) Int. Cl. F15B 11/00

(52) U.S. Cl. 91/508

(57) ABSTRACT

A crank device and an adjusting device of a combustion engine. The system adjusts the cylinder pressure of the motor in accordance with the required power. Adjustment of the cylinder pressure takes place by changing the compression ration by means of the adjusting device (19). The adjusting device (19) changes an eccentric wheel (3) through an adjusting wheel (4) to a such position that a connecting rod (2) lifts a piston (1) to a desired distance from the combustion chamber head. The adjusting device measures the volume of the air entering the cylinder and adjust the compression ratio to be appropriate. The adjusting device also takes into account the speed of rotation so that the compression pressure increases or decreases to be appropriate.

### BACKGROUND OF THE INVENTION

1. Technical Field

The present invention relates to a motor which comprises a motor compression pressure adjuster and wherein a connecting rod is provided from a piston of the motor to the directions of a crank arm, the connecting rob being mounted by bearings to an eccentric wheel, wherein the eccentric wheel is provided with a gear ring that is centered on the crank arm and the eccentric wheel is driven by an adjusting wheel.

2. Background of the Invention

In the known motors a connecting rod is mounted on bearings on a crank arm shaft. When a piston is in the top position the combustion chamber is the same in the entire rotation speed range. With short filling the compression pressure remains low resulting in substantially poor performance.

When the speed of rotation increases the combustion chamber increases relatively quicker than on low speeds. Because of this the pressure in the cylinder does not increase on a sufficiently high level and this decreases the power of the motor.

In conventional motors when the piston is in the upper dead centre the crank arm and the connecting rod are on the same line and the length of the lever is zero. Therefore the torque is also temporarily zero.

### SUMMARY OF THE INVENTION

The invention aims to remove the above mentioned disadvantages and provide a motor which has substantially lower loss of thermal energy, increased output per litre and which decreases CO2 emissions about 38% compared to conventional motors.

This aim can be achieved in accordance with the invention by using a compression pressure adjuster and by it use an adjusting wheel 4 to adjust the position of an eccentric wheel on the crank arm shaft.

Gearwheels shall be dimensioned by means of the equation on page 2. An eccentric wheel is mounted on bearings at the lower end of the connecting rod and in the crank arm. The eccentric wheel has a fixed gear ring 3 positioned centrally on the crank arm shaft. The gear ring 3 is driven by the adjusting wheel 4. A computer and an adjusting device 19 move the adjusting wheel 4 to a position required by a sufficient cylinder pressure.

When the adjusting device 19 moves the adjusting wheel 4 counter clockwise the combustion chamber decreases and the pressure increases. Correspondingly, the pressure remains lower when the adjusting wheel is turned clockwise.

More particularly, the motor in accordance with the invention comprises a motor compression pressure adjuster and wherein a connecting rod is provided from a piston of the motor to the direction of a crank arm, the connecting rod being mounted by bearings to an eccentric wheel, wherein the eccentric wheel is provided with a gear ring that is centred on the crank arm and the eccentric wheel is driven by an adjusting wheel, and the eccentric wheel and adjusting wheel are dimensioned so that the radius of the crank arm+the rolling radius of the gear ring of the eccentric wheel=rolling radius of the adjusting wheel.

### BRIEF DESCRIPTION OF THE DRAWINGS

In the following, the invention is described in more detail with reference to the annexed drawings, which show in sectioned drawings a motor construction in accordance with the invention.

FIG. 1 is a schematic representation of one embodiment of the present invention.

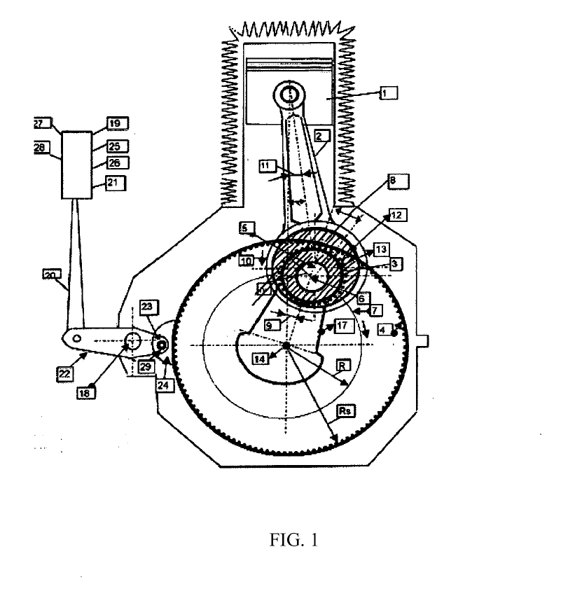

### DETAILED DESCRIPTION

Part 2 of a motor is manufactured from metal so that it is possible to mount at the crank arm side end thereof an eccentric wheel 3, wherein a gear ring centred on the crank arm is fixed therein. The gear ring of the eccentric wheel is in contact with the gear ring of the adjusting wheel 4.

The adjusting wheel 4 is mounted on the body of the motor such that it can be turned back and forth in the range of 0-30°. To turn the adjusting wheel 4 it is provided with a turning shoulder 24 to which a swinging arm 22 is attached.

The winging arm 22 in fixed to a shaft 18. Turning apparatus are attached to the shaft 18 for turning of each adjusting gear ring.

The adjusting device 19 takes into account the speed of rotation, required power and filling ratio of the motor.

The eccentric wheel rotates in a direction opposite to the crank shaft of the motor. The rolling radius rv of the gear ring of the eccentric wheel and the rolling radius Rs of the adjusting gear ring shall be dimensioned so that Rs=R +rv=2.5*rv.

The moving wheel 4 of each cylinder is moved by shaft 18 and the therein fixed swinging arms 22. By means of this the adjustment is provided simultaneously in each cylinder.

The system provides a greater angle 9 of the connecting rod in the beginning of a combustion stroke, thereby increasing the leverage arm, and correspondingly at the end of the combustion stroke it decreases the angle of the connecting rod and decreases the friction between the piston and the cylinder wall.

In case of short filling the combustion chamber decreases and the distance to the fire front is shortened as is the time of fire. The shorter time of fire and greater compression ratio provide sufficiently high pressure in the cylinder.

In greater rotation speeds the cylinder pressure is increased by changing the compression ratio. The structure provides a greater piston speed and higher cylinder pressure during the combustion stroke. The combustion chamber increases rapidly and the pressure does not increase too much.

By changing the combustion chamber the pressure in the cylinder is adjusted to the knocking border and the temperature as high as the structure of the motor allows. The high temperature increases resistance to thermal conductivity and thereby losses in thermal energy can be decreased.

1. A motor comprising:
a motor compression pressure adjuster and wherein
a connecting rod is provided from a piston of the motor to the direction of a crank arm, the connecting rod being mounted by bearings to an eccentric wheel, wherein the eccentric wheel is provided with a gear ring that is centred on the crank arm and the eccentric wheel is driven by an adjusting wheel,
characterized in that the eccentric wheel and adjusting wheel are dimensioned so that the radius of the crank arm+the rolling radius of the gear ring of the eccentric wheel=rolling radius of the adjusting wheel.

2. A motor in accordance with claim 1, wherein the rolling radius of the adjusting wheel is in the order of 2.5 times the rolling radius of the gear ring of the eccentric wheel.

3. A motor in accordance with claim 1, wherein an adjusting device adjusts by means of a shifting arm and a turning arm the adjusting wheel into a desired position.

4. A motor in accordance with claim 1, comprising a turning arm for adjusting the position of the eccentric wheel, the turning arm being attached to an adjustment shaft.

5. A motor in accordance with claim 4, wherein the adjustment shaft is adapted to turn an adjusting wheel of each cylinder.

6. A motor in accordance with claim 1, wherein an adjusting wheel of each cylinder is provided with a turning shoulder and a shock absorber for absorbing shocks.

7. A motor in accordance with claim 1, comprising an adjusting device adapted to measure the filling ratio of the cylinder, speed of rotation and required power.

8. A motor in accordance with claim 7, wherein the adjusting device is adapted to change the compression ratio to provide an optimal compression pressure in the cylinder.

9. A method for adjusting compression pressure in a cylinder of a motor where a connecting rod is mounted by bearings to an eccentric wheel on a crank arm and the eccentric wheel is provided with gear ring centred on the crank arm and engaging with teething of an adjusting wheel, the method comprising adjusting the position of the eccentric wheel relative to the crank arm by turning the adjusting wheel by means of a turning arm pivotally attached to the adjusting wheel, wherein the adjusting wheel is dimensioned so that the sum of the radius of the crank arm and the rolling radius of the gear ring of the eccentric wheel equals the rolling radius of the teething of the adjusting wheel.

10. A method as claimed in claim 9, wherein the rolling radius of the teething of the adjusting wheel is about 2.5 times the rolling radius of the gear ring of the eccentric wheel.

11. A method as claimed in claim 9, further comprising adjusting the position of the eccentric wheel by pivoting the turning arm about an adjustment shaft.

12. A method in accordance with claim 11, comprising adjusting the position of a plurality of eccentric wheels by the turning the adjustment shaft about the adjustment shaft.
